(19) United States
(12) Patent Application Publication
(10) Pub. No.: US 2020/0315193 A1
(43) Pub. Date: Oct. 8, 2020

(54) METHOD AND SYSTEM FOR PACKAGING LIVE CLAMS IN A CONTAINER

(71) Applicant: SOUTHEASTERN SEAPRODUCTS, INC., Melbourne, FL (US)

(72) Inventor: Mark MAYNARD, SR., Melbourne, FL (US)

(21) Appl. No.: 16/374,336

(22) Filed: Apr. 3, 2019

(51) Int. Cl. A22C 29/04; A23L 17/40; B65B 25/00; A23L 17/50; B65D 85/50

(52) U.S. Cl. CPC A22C 29/043; A23L 17/40; A23V 2002/00; A23L 17/50; B65D 85/50; B65B 25/001

(57) ABSTRACT

A method is provided for packaging live clams in a container. The method includes harvesting the live clams from sea water having a first temperature. The method further includes placing the live clams in a tank of sea water having a second temperature that is less than the first temperature. The method further includes drying, with a blowing device, an outside surface of the live clams after removing the live clams from the tank. The method further includes placing a number of the live clams in the container after the drying step. The method further includes applying a vacuum seal along a top of the container and over the live clams in the container.

### FIELD OF THE INVENTION

The present invention relates to live clams, and more particularly, to a method and system for packaging live clams in a container, such as a container for storage or shipment.

### BACKGROUND

Live clams are conventionally packaged in a mesh bag 200 as shown in FIG. 6. The mesh bag 200 is typically placed in a shipping container and transported using a vehicle to a receiving location (e.g. retail store, restaurant, etc.). However, for the reasons discussed herein, the live clams packaged in the mesh bags 200 have a limited shelf life, due to the mesh bag 200 packaging. Hence, clam harvesters are severely restricted in terms of the shipping radius of the live clams using this conventional packaging.

### SUMMARY OF THE INVENTION

The inventor identified various drawbacks with the conventional mesh bag 200 that is used to package the live clams. For example, the inventor recognized that the shelf life of the live clams (e.g. a number of days that the live clams remain alive) is limited based on the mesh bag 200 packaging. Specifically, the inventor recognized that the shelf life is limited (e.g. 7 days or less), since the mesh bag 200 fails to replicate one or more environmental conditions of the live clams in their natural ocean environment. For example, the inventor recognized that live clams in their natural ocean environment have external pressure applied to their shell from sand that surrounds them when they are buried under the sea floor. However, the inventor recognized that the mesh bag 200 only applies external pressure to some claims 220b along an outer perimeter of the mesh bag 200 and fails to apply external pressure to other claims 220a on top of the other live clams. Indeed, no external pressure is applied to these claims 220a in the mesh bag 200. The inventor developed a packaging system and method for live clams which addresses this shortcoming of the conventional mesh bag 200 and ensures that external pressure is applied to each live clam in the packaging.

Another environmental condition of the live clams that is not replicated by the conventional mesh bag 200 is atmospheric content. For example, the inventor recognized that live clams in the conventional mesh bag 200 are exposed to the earth's atmosphere which is about 20% oxygen or about 200,000 parts per million (PPM) oxygen, whereas live clams in their natural ocean environment typically experience about 1-6 PPM oxygen. The inventor also recognized that this mismatch between the PPM of oxygen experienced by live clams in the mesh bag 200 and the PPM of oxygen in the ocean further limits the shelf life of the clams in the mesh bag 200. The live clams are stressed by this excess of oxygen in the atmosphere of the mesh bag 200, which limits their shelf life. The inventor developed a packaging system and method which addresses this shortcoming of the conventional mesh bag 200 and ensures that the atmospheric content (e.g. PPM of oxygen) experienced by the live clams in the packaging is similar to that of the natural ocean environment.

Another environmental condition of the live clams that is not replicated by the conventional mesh bag 200 is that the live clams remain dry. For example, the inventor recognized that since the live clams in the conventional mesh bag 200 do not each have external pressure applied to their shell, they eventually tire from having to keep their shell closed and eventually open and release water on the other clams. This causes the other live clams to falsely believe that the tide has come in and that it is time to feed, hence they all open their shells and release water. Since the live clams need to retain the water in their shells to extend the shelf life (since the water includes an appropriate level of dissolved oxygen), this process in the conventional mesh bag 200 severely reduces the shelf life of the live clams. The inventor developed a packaging system and method which addresses this shortcoming by ensuring that the live clams are dried prior to being packaged and remain dry during the packaging and shipment.

In one embodiment, a method is provided for packaging live clams in a container. The method includes harvesting the live clams from sea water having a first temperature. The method further includes placing the live clams in a tank of sea water having a second temperature that is less than the first temperature. The method further includes drying, with a blowing device, an outside surface of the live clams after removing the live clams from the tank. The method further includes placing a number of the live clams in the container after the drying step. The method further includes applying a vacuum seal along a top of the container and over the live clams in the container.

In another embodiment, a system is provided for packaging live clams in a container. The system includes a tank of sea water at a second temperature, where the tank is configured so that live clams harvested from sea water having a first temperature greater than the second temperature and placed in the tank. The system further includes a blowing device configured to dry an outside surface of the live clams after being removed from the tank. The system further includes a vacuum skin machine configured to apply a vacuum seal along a top of a container in which a number of the live clams are placed and configured to apply the vacuum seal over the live clams in the container.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

The novel features which are considered characteristics of certain embodiments of the present invention are set forth in the appended claims. Embodiments of the invention relating to construction and method of operation embodiments, together with additional advantages thereof, will be best understood from the following description of the specific embodiments when read and understood in connection with the accompanying drawings.

### BRIEF DESCRIPTION OF THE DRAWINGS

Embodiments are illustrated by way of example, and not by way of limitation, in the figures of the accompanying drawings in which like reference numerals refer to similar elements and in which:

FIGS. 1A and 1B are block diagrams that illustrate one example of a system for packaging live clams in a container, according to an embodiment;

FIG. 2A is an image that illustrates one example of a container holding dry live clams in the system of FIGS. 1A and 1B, according to an embodiment;

FIG. 2B is an image that illustrates one example of the container of FIG. 2A positioned in the vacuum skin machine of the system of FIGS. 1A and 1B, according to an embodiment;

FIG. 2C is an image that illustrates one example of the vacuum skin machine moving the container of FIG. 2B upwards to apply the vacuum seal, according to an embodiment.

FIG. 2D is an image that illustrates one example of the container of FIG. 2C lowered by the vacuum skin machine and with the applied vacuum seal, according to an embodiment;

FIGS. 2E and 2F are images that illustrate one example of the vacuum sealed container of FIG. 2D, according to an embodiment;

FIG. 2G is an image that illustrates an example of the vacuum sealed container of FIG. 2D where the vacuum seal includes an easy pull tab, according to an embodiment;

FIG. 3 is an image that illustrates an example of a vacuum skin machine of the system of FIGS. 1A and 1B, according to an embodiment;

FIG. 4A is a graph that illustrates an example of curves depicting dissolved oxygen content versus temperature for fresh water and sea water, according to an embodiment;

FIG. 4B is a bar graph that illustrates an example of a percentage of saleable live clams versus number of days after harvest, for conventional packaged live clams and live clams packaged using the system of FIGS. 1A and 1B, according to an embodiment;

FIG. 4C is a block diagram that illustrates an example of a package in which one or more containers are inserted, according to an embodiment;

FIG. 4D is a block diagram that illustrates an example of a shipping container in which one or more packages of FIG. 4C are inserted, according to an embodiment;

FIGS. 4E and 4F are views that illustrate an example of a container used in the system of FIG. 1B, according to an embodiment;

FIGS. 4G and 4H are views that illustrate an example of a container used in the system of FIG. 1B, according to an embodiment;

FIG. 5 is a flow chart that illustrates an example of a method for packaging live clams in a container, according to an embodiment; and

FIG. 6 is an image that illustrates an example of a top view of live clams packaged in a conventional mesh bag.

### DETAILED DESCRIPTION

A method and apparatus are described for packaging and transporting live clams. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of packaging live clams, including packaging live clams for transport or for storage. In other embodiments, the invention is described below in the context of packaging any live bivalve mollusk or any live sea protein. In an example embodiment, the live clams are transported to a second location, (e.g. restaurant, hotel, etc.) where they are served. Other embodiments of the invention are described in the context of the assembly or system that is used to package and transport the live clams. Still other embodiments of the invention are described in the context of a method for serving the live clams from the package assembly after it is shipped to a location (e.g. restaurant, hotel, etc.) to be served.

In an embodiment, the term “shelf life” is defined herein to mean a duration of time after packaging live clams or harvesting live clams that the live clams remain in a saleable condition, where saleable condition means that the live clams are alive.

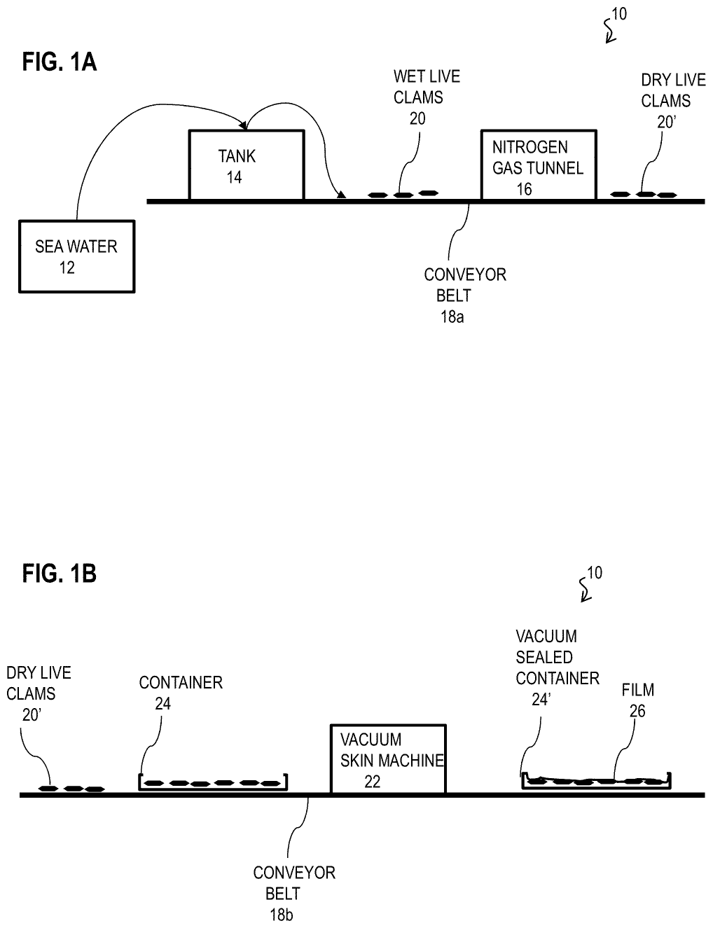

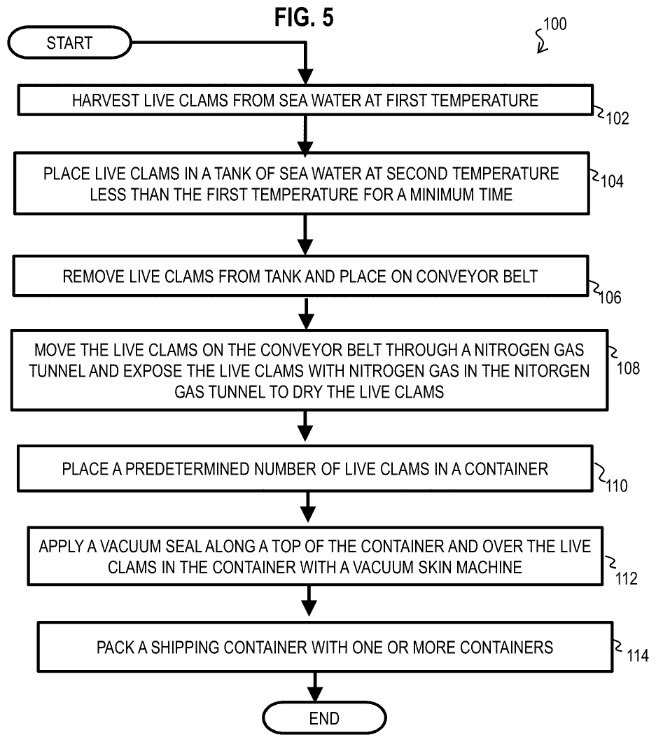

FIGS. 1A and 1B are block diagrams that illustrate one example of a system 10 for packaging live clams 20′ in a container 24, according to an embodiment. FIG. 5 is a flow chart that illustrates an example of a method for packaging live clams 20 in the container 24, according to an embodiment. Although steps are depicted in FIG. 5 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 102, live clams 20 are harvested from sea water 12 at a first temperature. In an embodiment, the clams 20 are harvested from sea water 12 that is either a clam farm (e.g. farm raised clams) or the ocean (e.g. wild caught clams). The clams 20 are harvested from the sea water 12 using any steps that are appreciated by one of ordinary skill in the art.

In some embodiments, the sea water 12 is in a tropical region and/or has a temperature in a range between 80 F and 100 F and/or in a range between 85 F and 95 F and/or a temperature of about 90 F. The inventor recognized that harvesting clams 20 from sea water 12 in tropical regions is particularly challenging, since the dissolved oxygen level of the sea water 12 in tropical regions is relatively low (e.g. compared to sea water in non-tropical regions with lower temperature). Since packaged live clams have a shelf life that is dependent on the dissolved oxygen levels of water in their shell, live clams harvested in these tropical regions has a limited shelf life and thus has a limited shipping radius. Consequently, harvesters in tropical regions have limited supply of retailers to whom they can sell live clams 20, despite that the harvesters in tropical regions can harvest clams more frequently (e.g. in about 12 months) than harvesters in non-tropical regions (e.g. in about 3 years). Thus, the inventor recognized that clam harvesters in tropical regions have a particular challenge, since they have a relatively abundant supply of live clams 20 and yet a relatively limited supply of retailers to sell the live clams 20. In an embodiment, the inventor developed the method and system disclosed herein to solve this particular challenge.

Dissolved oxygen is necessary to many forms of life including fish, invertebrates, bacteria and plants. These organisms use oxygen in respiration, similar to organisms on land. Fish and crustaceans obtain oxygen for respiration through their gills, while plant life and phytoplankton require dissolved oxygen for respiration when there is no light for photosynthesis. The amount of dissolved oxygen needed varies from creature to creature. Bottom feeders, crabs, oysters, clams and worms need minimal amounts of oxygen (e.g. 1-6 mg/L or PPM), while shallow water fish need higher levels (e.g. 4-15 mg/L or PPM).

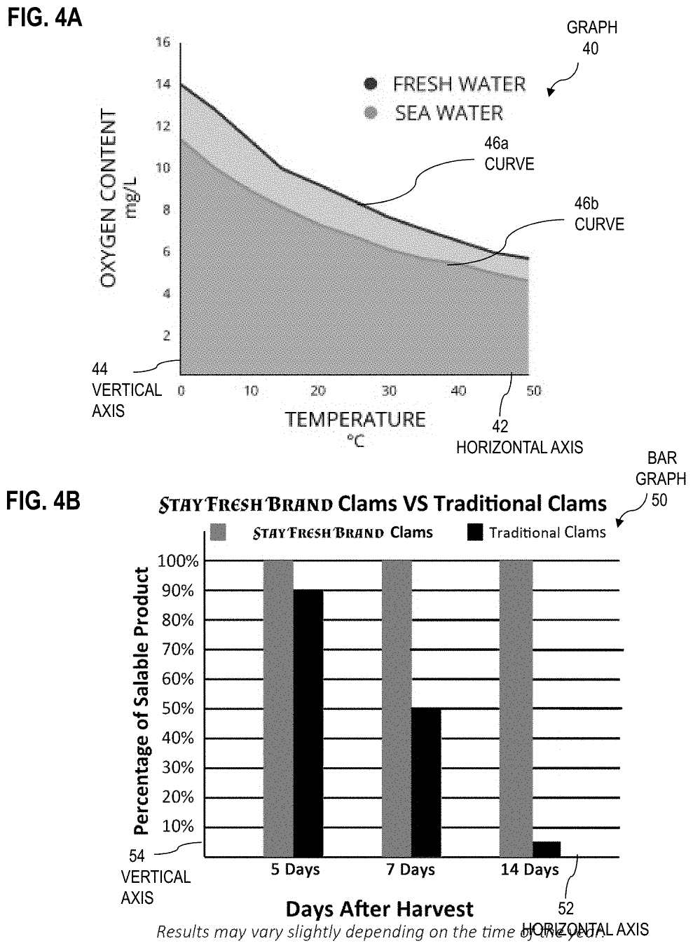

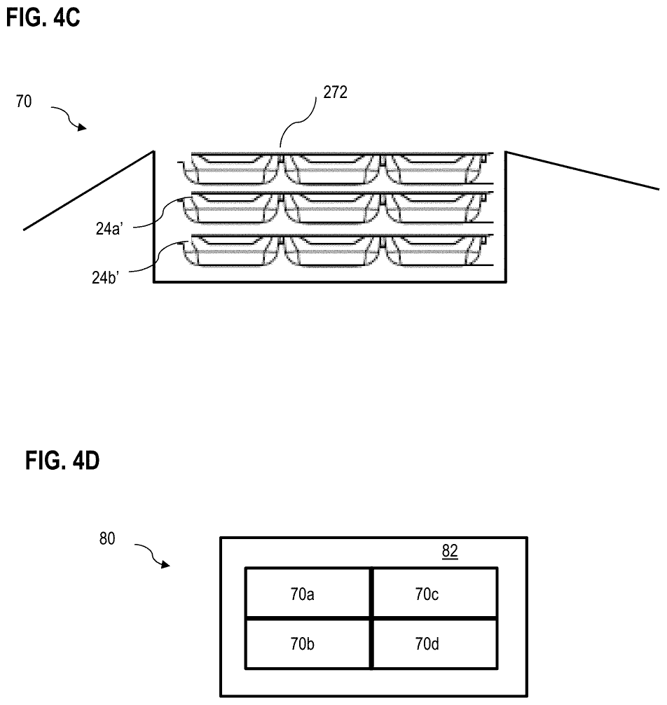

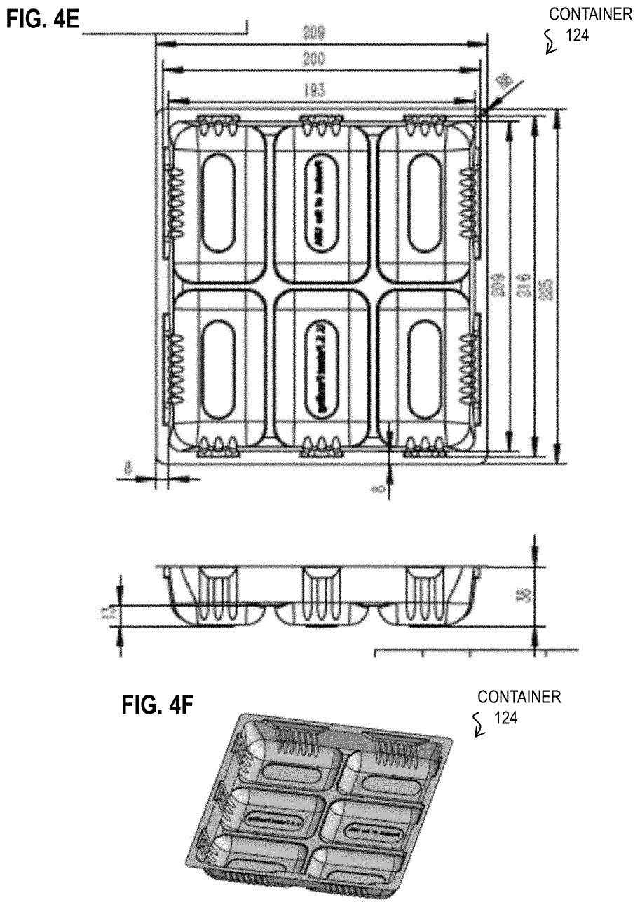

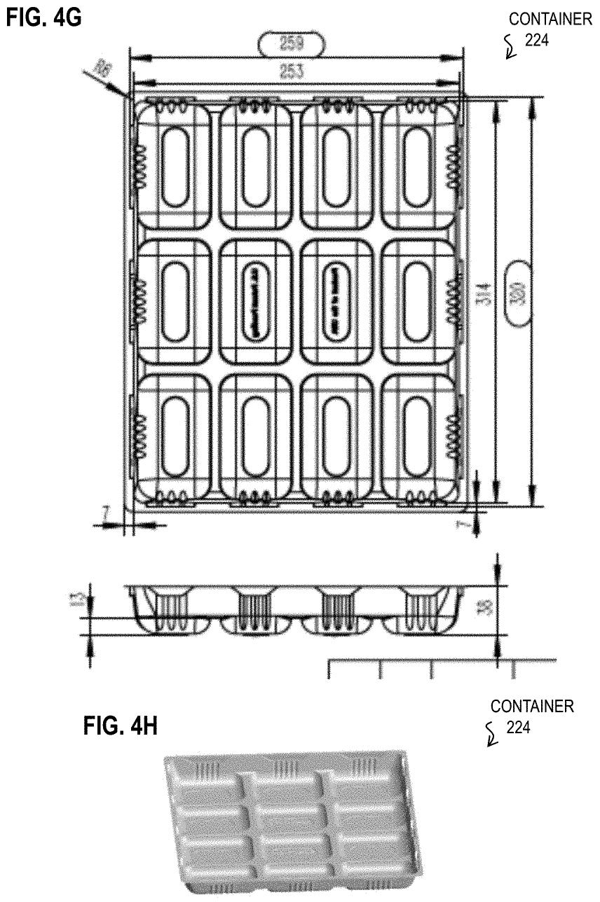

Two bodies of water (e.g. fresh water, sea water) do not necessarily have the same concentration of dissolved oxygen. FIG. 4A is a graph 40 that illustrates an example of dissolved oxygen content versus temperature for fresh water and sea water, according to an embodiment. The horizontal axis 42 is water temperature in units of degrees Celsius (C). The vertical axis 44 is dissolved oxygen content in units of mg/L or PPM. A first curve 46a indicates the dissolved oxygen level in fresh water for different water temperature. A second curve 46b indicates the dissolved oxygen level in sea water for different water temperature. In an embodiment, the second curve 46b indicates that the dissolved oxygen level of tropical region sea water 12 (e.g. about 90 F or 32 C temperature) is about 6 mg/L or 6 PPM. Thus, in an example embodiment, the dissolved oxygen level of the sea water 12 is about 6 mg/L or 6 PPM.

In step 104, the live clams 20 harvested in step 102 are placed in a tank 14 with sea water having a second temperature that is less than the first temperature of the sea water 12. The system 10 includes the tank 14 where the live clams 20 removed from the sea water 12 are placed. In an embodiment, the tank 14 includes sea water with a temperature that is less than the temperature of the sea water 12. In an embodiment, the sea water in the tank 14 is moved (e.g. using an underwater device such as a jet or propeller) over the live clams 20 to enhance the absorption of the dissolved oxygen level from the sea water and/or to remove the sand from the gills of the live clams 20. In an example embodiment, the temperature of the sea water in the tank 14 is in a range from about 45 F to about 70 F. In yet another example embodiment, the temperature of the sea water in the tank 14 is in a range from about 50 F to about 60 F. The second curve 46b of FIG. 4A indicates that the dissolved oxygen level in the sea water of the tank 14 (e.g. from about 55 F to about 60 F) is about 8-9 mg/L or 8-9 PPM. Thus, the dissolved oxygen level of the sea water in the tank 14 is higher than the dissolved oxygen level of the sea water 12 from which the live clams 20 were harvested. The inventor recognized that placing the live clams 20 in sea water with a relatively high dissolved oxygen content prior to shipment advantageously extends the shelf life of the live clams 20, since water with a higher dissolved oxygen content is in the clam shells during shipment.

In an embodiment, the live clams 20 are left in the tank 14 for a minimum time that is sufficient for the live clams to absorb the higher dissolved oxygen level of the sea water in the tank 14 and/or for the water in the tank 14 to enter the shells of the live clams 20. In one embodiment, the minimum time is at least about 1 hour. In another embodiment, the minimum time is at least about 2 hours. In yet another embodiment, the minimum time is at least about 6 hours. In another embodiment, the minimum time is about 12 hours. Additionally, in another embodiment, placement of the live clams 20 in the tank 14 advantageously removes sand from the gills of the clams 20. As appreciated by one skilled in the art, as the live clams 20 take in the sea water in the tank 14 they eject the sand from their gills.

In step 106, the live clams 20 are removed from the tank 14. In an embodiment, in step 106, the live clams 20 are removed from the tank 14 and placed on a conveyor belt 18a. In one embodiment, after the minimum time has elapsed, the live clams 20 are removed from the tank 14 and positioned on the conveyor belt 18a. In an embodiment, the live clams 20 are positioned on the conveyor belt 18a so that they are spaced apart by a minimum spacing. In an embodiment, the live clams 20 are positioned on the conveyor belt 18a so that they form a single layer and are not on top of each other. In some embodiments, in step 106 the live clams 20 are merely placed on a surface (e.g. horizontal surface) other than a conveyor belt 18a.

In step 108, the live clams 20 are dried. In an embodiment, in step 108, the live clams 20 are dried using a blowing device and the conveyor belt 18a moves the clams 20 relative to and/or through the blowing device. In an embodiment, the conveyor belt 18a moves the live clams 20 through a blowing device or drying device that is configured to blow cooling air or cooling gas or cooling fluid on the outer surface of the clams 20 on the conveyor belt 18 so to dry and/or cool the external surface of the live clams 20. In other embodiments, no conveyor belt 18a is present and the blowing device or drying device is moved relative to the clams 20 positioned on a surface, to dry the outer surface of the clams 20. In one embodiment, the blowing device is a nitrogen gas tunnel 16 where nitrogen gas is released through a series of manifolds and then jet sprays. In an embodiment, the nitrogen gas acts as a cooling agent and a drying agent. In an embodiment, one or more settings of the nitrogen gas tunnel 16 are adjusted, so that the live clams 20 are exposed to the nitrogen gas at a selective temperature and for a selective time, so that the external surface of the clams 20 are dried while at the same time the clams 20 are not frozen or killed. In an example embodiment, the selective temperature is in a range from about −100 F to about 10 F or in a range from about −50 F to about −10 F or in a range from about −30 F to about −20 F. In another example embodiment, the selective time is in a range from about 2 minutes to about 8 minutes or in a range from about 4 minutes to about 6 minutes or about 5 minutes. In an example embodiment, the nitrogen gas tunnel 16 is a Model 1940 manufactured by Praxair®, Inc of Danbury, Conn. Although a nitrogen gas tunnel is discussed here as one example of the blowing device, the embodiments of the present invention is not limited to use of a nitrogen gas tunnel or nitrogen gas to dry the outer surface of the clams 20 or even to using a conveyor belt 18. Instead, any device appreciated by one of ordinary skill in the art that can be used to dry the outer surface of the clams 20 can be used as the blowing device, with or without the conveyor belt 18.

In an embodiment, the live clams travel on the conveyor belt 18a at a speed of about 3.15 feet per minute or in a range from about 2 feet per minute to about 5 feet per minute. In another embodiment, the live clams 20 are cooled by the blowing device to an internal temperature in a range from about 30 F to about 50 F or in a range from about 35 F to about 45 F or a temperature of about 40 F. Additionally, in another embodiment, the outer surface of each live clam 20′ is now dry upon emerging from the blowing device.

In step 110, a predetermined number of live clams 20′ dried in step 108 are placed in the container 24. In an embodiment, after the outer surface of the live clams 20′ are dried by the blowing device, the predetermined number of live clams 20′ are placed in the container 24. In some embodiments, the predetermined number of live clams 20′ positioned in the container 24 depends on the size or species of the live clams 20′. In an example embodiment, for smaller sized clams (e.g. littleneck clams or mercenaria mercenaria) a higher number of live clams 20′ (e.g. 100) are positioned in the container 24. In another example embodiment, for larger sized clams (e.g. middleneck clams or mercenario camphensis), a lower number of live clams 20′ (e.g. 50) are positioned in the container 24. In yet another embodiment, the predetermined number of live clams 20′ positioned in the container 24 depends on the vendor where the clams are being shipped. In an example embodiment, a lower number (e.g. one dozen, two dozen) are positioned in the container 24 for retail vendors, whereas a higher number (e.g. 50, 100, etc.) are positioned in the container 24 for food service or wholesale vendors. In an example embodiment, the container 24 has a square or rectangular shape and a cavity defined by a rim that extends around the top perimeter of the container 24. FIGS. 4E and 4F are views that illustrate an example of a container 124 used in the system of FIG. 1B, according to an embodiment. In one embodiment, the container 124 includes a plurality (e.g. six) number of flat regions with a raised region between adjacent flat regions. In an example embodiment, dimensions of the container 124 are depicted in FIGS. 4E and 4F, in units of millimeters (mm), however the container 124 is not limited to these particular dimensions and can be formed with any particular dimensions. FIGS. 4G and 4H are views that illustrate an example of a container 224 used in the system of FIG. 1B, according to an embodiment. The container 224 is similar to the container 124, with the exception that the container 224 has a greater number (e.g. twelve) number of flat regions with the raised region between adjacent flat regions. In some embodiments, the container 24 just includes one flat region and does not include raised region as depicted in the containers 124, 224 of FIGS. 4E-4H. The system and method described herein can be performed with respect to the containers 124, 224 in a similar manner as described herein with respect to the container 24. In an embodiment, the live clams 20′ are positioned in the container 24 to form a single layer of clams 20′ and/or so that multiple layers of clams 20′ are not present in the container 24. In an example embodiment, the live clams 20′ are sorted and/or evenly distributed in the container 24 so that the single layer of live clams 20′ is achieved. This advantageously ensures that the applied vacuum seal applies pressure to the outer surface of each live clam 20′. In some embodiments, a single layer of live clams 20′ are provided in the container 24 and the vacuum seal applies the pressure to the outer surface of each live clam 20. In other embodiments, multiple layers of live clams 20′ are provided in the container 24 and the vacuum seal applies the pressure to the outer surface of each live clam 20 on an outer layer which in turn applies pressure to each live clam 20′ in an inner layer, so that external pressure is applied to each live clam 20′ in the container 24.

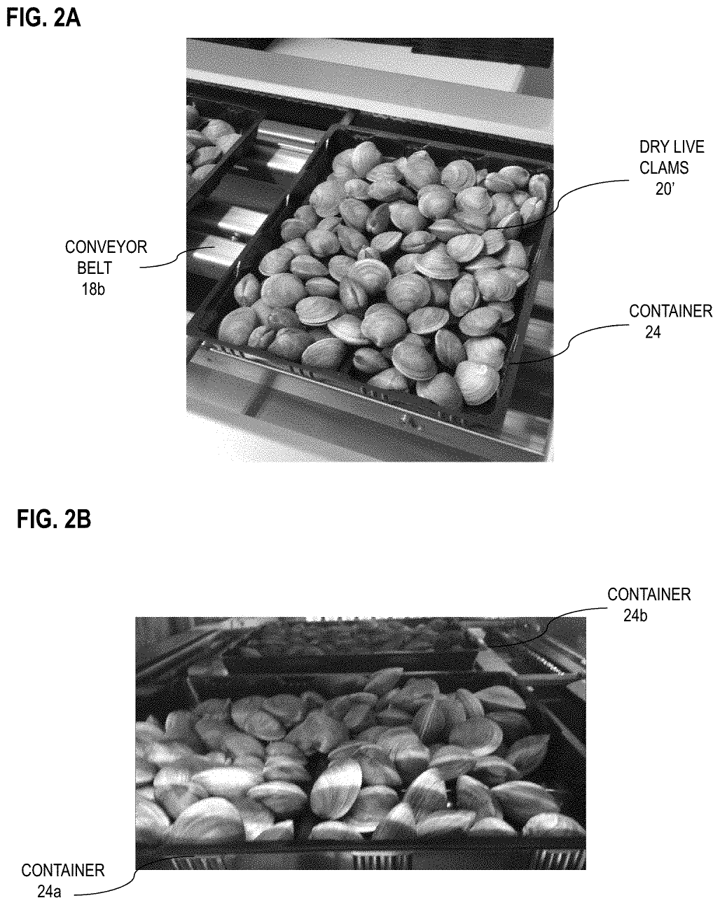

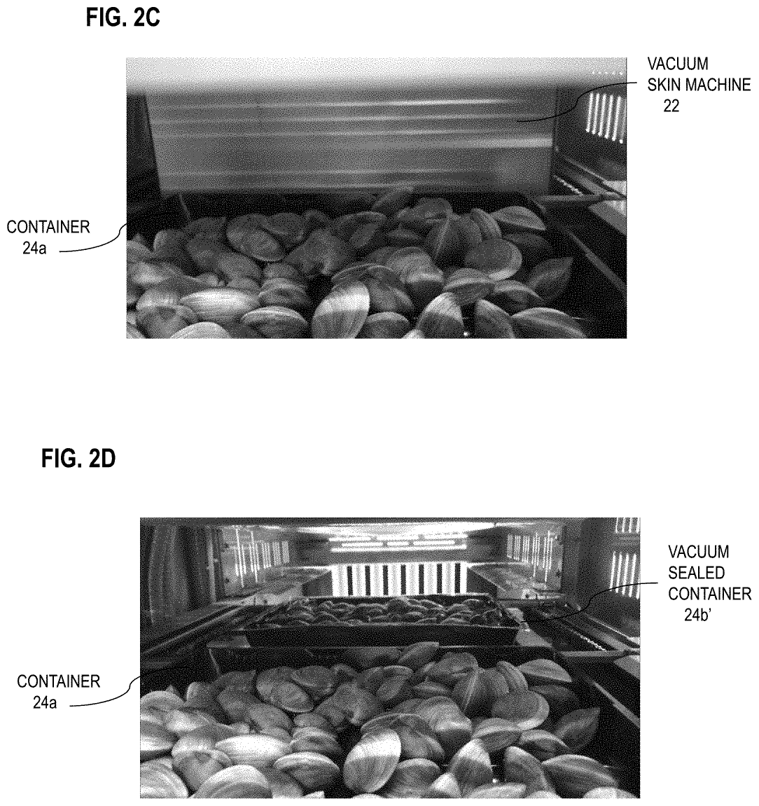

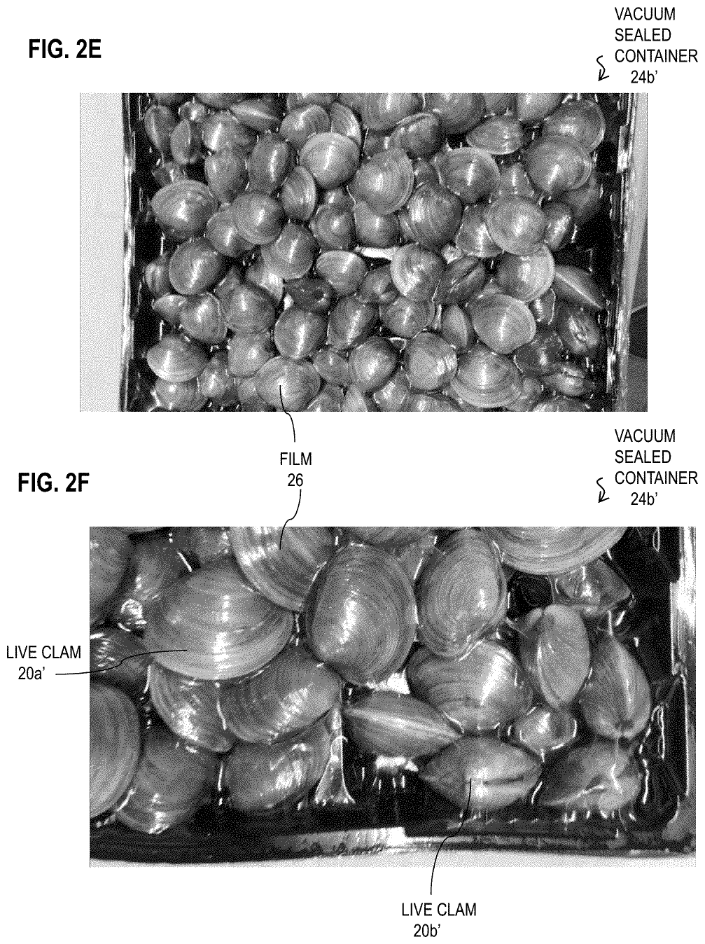

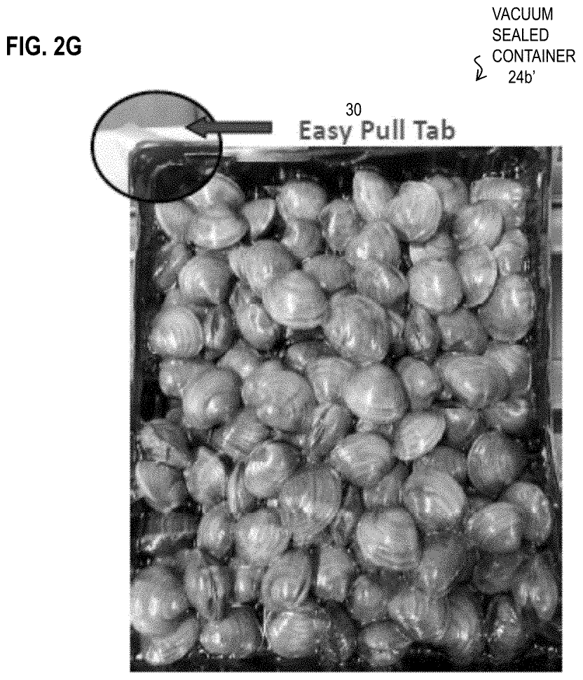

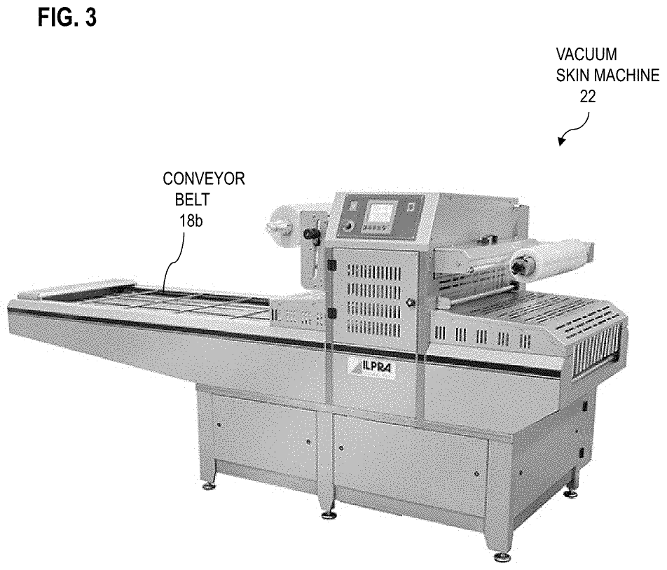

In step 112, a vacuum seal is applied along a top of the container 24 and over the live clams 20 in the container 24. FIG. 2A is an image that illustrates one example of a container 24 holding dry live clams 20′ in the system of FIGS. 1A and 1B, according to an embodiment. The container 24 is positioned on a conveyor belt 18b which may or may not be the same as the conveyor belt 18a. In some embodiments, the conveyor belt 18b is merely a guide rail along which the container 24 is manually slid by a user. FIG. 3 is an image that illustrates an example of a vacuum skin machine 22 of the system 10 of FIGS. 1A and 1B, according to an embodiment. In an embodiment, the conveyor belt 18b is depicted and is configured to move the container 24 into the vacuum skin machine 22 so that the vacuum seal can be applied along the top of the container 24 and over the live clams 20 in the container 24. In one embodiment, the vacuum skin machine 22 is a Foodpack Speedy 2 EMEC®, model number EP10154 manufactured by ILPRA® of Mortara Italy. In an example embodiment, the vacuum skin machine 22 includes one or more parameters including a length in a range of about 3000-4000 mm, a width in range of about 1000-2000 mm and a height in a range of about 1000-2000 mm; a weight in a range of about 500-1500 kg; an installed power of about 13 kW; an air consumption of about 4-8 bar-1t/ciclo; a maximum tray size of about 640 mm length×330 mm width×135 mm height; a sealing area of about 640 mm×330 mm (1 cycle); a length of loading area of about 4 steps and a maximum diameter of reels in a range from about 200-400 mm.

FIG. 2B is an image that illustrates one example of the container 24b of FIG. 2A positioned in the vacuum skin machine 22 of the system 10 of FIGS. 1A and 1B, according to an embodiment. The container 24b has been moved by the conveyor belt 18b into the vacuum skin machine 22 and is positioned within the vacuum skin machine 22 so that the vacuum seal can be applied to the top of the container 24b and over the live clams. FIG. 2B also depicts another container 24a that is positioned on the conveyor belt 18b outside the vacuum skin machine 22 and is yet to be moved into the vacuum skin machine 22 for application of the vacuum seal. FIG. 2C is an image that illustrates one example of the vacuum skin machine 22 moving the container 24b of FIG. 2B upwards to apply the vacuum seal, according to an embodiment. In an embodiment, the container 24b (not shown in FIG. 2B) is moved upwards by the skin machine 22 for application of the vacuum seal around the rim along the top of the container 24b and over the live clams 20. FIG. 2D is an image that illustrates one example of the container 24b′ of FIG. 2C lowered by the vacuum skin machine 22 and with the applied vacuum seal, according to an embodiment.

FIGS. 2E and 2F are images that illustrate one example of the vacuum sealed container 24b′ of FIG. 2D, according to an embodiment. In an embodiment, the vacuum sealed container 24b′ features a film 26 applied by the vacuum skin machine 22 around the rim of the top of the container 24b and over the outer surface of the live clams 20′ positioned in the container 24b′. In an embodiment, one or more parameters of the vacuum skin machine 22 are adjusted so that air (e.g. atmosphere air including nitrogen, oxygen, etc.) is removed from the interior of the container 24 prior to application of the film 26. In an example embodiment, the one or more parameters of the vacuum skin machine 22 are adjusted so that after removing the air from the interior of the container 24 prior to applying the film 26, the atmosphere within the sealed container resembles the atmosphere of the live clams 20 in the natural ocean environment. In an example embodiment, the atmosphere of the interior of the sealed container 24′ has a level of dissolved oxygen that is in the range of dissolved oxygen level (e.g. 1-6 mg/L or PPM) of the sea water in the natural ocean environment of the live clams 20 and/or within a broader range encompassing the range of dissolved oxygen level of the sea water in the natural ocean environment (e.g. 1-15 mg/L or PPM). In an example embodiment, one or more parameters of the vacuum skin machine 22 are adjusted so that the sealed container 24′ has an oxygen level (PPM) that is very low and in a range of sea water (e.g. from about 1 PPM to about 15 PPM) and/or in a range that is proximate to the range of sea water.

In an example embodiment, one or more parameters of the vacuum skin machine 22 are adjusted so that the external pressure applied by the film 26 onto the live clams 20′ is in a range of the external pressure applied to the live clams 20′ in a natural ocean environment (e.g. external pressure applied by sand to the live clams when they are buried under the ocean floor). In an example embodiment, the pressure applied by the film 26 is in a range from about 1 pound to about 3 pounds and/or in a range from about 0.5 pounds to about 5 pounds . In an example embodiment, the particular pressure applied by the film 26 is based on a size of the live clams 20′. In another example embodiment, the pressure applied by the film 26 is greater for live clams 20′ of greater size and smaller for live clams 20′ of smaller size. In an embodiment, the one or more settings of the vacuum skin machine 22 are adjusted so that the pressure is in the appropriate range, e.g. is not too high so that the live clams 20′ are damaged or crushed and not too low so that the live clams 20′ don't receive adequate external support to keep their shell closed and/or in a range from about 1 pounds to about 3 pounds and/or in a range from about 0.5 pounds to about 5 pounds. As depicted in FIG. 2F, some live clams 20a′, 20b′ are aligned at varying angles such as about orthogonal to each other. However, the applied film 26 advantageously replicates one or more parameters of the natural ocean environment of the live clams (e.g. external pressure of sand, PPM oxygen, dry external surface of clam shell, etc.).

In an embodiment, as depicted in FIGS. 2A-2B the containers 24a, 24b are positioned on the conveyor belt 18b so that the containers are each guided into the vacuum skin machine 22 so that a vacuum seal film 26 is applied along the top of each container 24a, 24b. In one embodiment, one or more settings of the vacuum skin machine 22 are adjusted, to provide various advantages in the packaging and storing of the live clams 20′. In one example embodiment, the vacuum setting of the vacuum skin machine 22 is adjusted to be about 85% or in a range from about 75% to about 95%. This vacuum setting advantageously minimizes the oxygen content within the sealed container 24b′ so that it is within the range of dissolved oxygen content (e.g. 1-6 mg/L or PPM) in the natural ocean environment of the live clams 20 or in a range of dissolved oxygen content (e.g. 1-15 mg/L or PPM) of a natural ocean environment. This extends the shelf life of the live clams 20′ and thus increases the shipping radius of the live clams 20′. In an example embodiment, containers 24 pass through the vacuum skin machine 22 at a rate of about 6 to 8 containers per minute or about 4 to 10 containers per minute.

In another example embodiment, the temperature of the film 26 prior to application is set to be about 190 degrees C. or in a range from about 150 degrees C. to about 220 degrees C. In yet another example embodiment, the containers 24a, 24b are made of a thermoplastic polymer material (e.g. poly propylene with a poly ethylene surface) to encourage the applied film 26 to bond enough to hold the vacuum while still permitting a customer to peel off the film 26 (e.g. easy pull tab 30 in FIG. 2G) when the live clams 20 are ready to serve. In yet another example embodiment, a thickness of the film 26 is selected to be about 6 mil (e.g. 1 mil=1/1000 inch) or in a range from about 4 mil to about 8 mil. This specific thickness of the film 26 is selected in order to ensure that the shell of the live clam 20 does not puncture the film 26 during or after packaging or transport of the container 24, thereby ensuring that the vacuum remains intact and extending the time period that the live clams 20 remain alive. As a result of the step 112, the resulting sealed containers 24a, 24b with vacuum seal films 26 over the top of the containers and over the live clams 20 in the containers are directed along the conveyor belt 18b out from the skinning machine 22. Although step 112 discuss that the vacuum skin machine 22 and conveyor belts 18a, 18b are used to apply the vacuum seal film 26, in other embodiments the conveyor belts 18a, 18b are not required and instead the vacuum seal film 26 is applied using machines which are hand loaded and unloaded to apply the vacuum seal film.

In step 114, a shipping container 80 is packed with one or more containers 24. In an embodiment, the shipping container 80 is transported to a location (e.g. vendor such as a retail store, restaurant, wholesale retailer, etc.). In an embodiment, in step 114, one or more sealed containers 24a′, 24b′ from step 112 are positioned in a box or package 70. FIG. 4C is an image that illustrates an example of a package 70 into which the sealed containers 24a′, 24b′ are inserted. Although FIG. 4C depicts three sealed containers 24a,', 24b′ inserted into the package 70, more or less than three sealed containers 24a′, 24b′ can be inserted into the package 70. In an embodiment, after the sealed containers 24a′, 24b′ are inserted into the package 70, the package 70 is sealed (e.g. the lid is closed and sealed). In an embodiment, one or more packages 70 are then provided in the shipping container 80. FIG. 4D depicts an image that illustrates an example of a shipping container 80 that includes a plurality of packages 70a, 70b, 70c, 70d, where each package includes one or more sealed container 24′. In an embodiment, refrigerant 82 encloses the packages 70a, 70b, 70c, 70d in the shipping container 80 to maintain the temperature of the live clams 20 in the containers 24 at a desired temperature (e.g. in a range between about 35 F and 50 F or about 40 F). In other embodiment, the refrigerant 82 is excluded and the shipping container 80 is transported on a vehicle whose internal temperature is the desired temperature (e.g. in a range between about 35 F and 50 F or about 40 F). In an embodiment, the inventor realized that shipping the live clams 20′ and containers 24 at the desired temperature advantageously extends the shelf life of the live clams, in addition to the method of packaging disclosed in FIG. 5. Additionally, the inventor recognized that the method of packaging and resulting sealed container 24′ for the live clams 20′ allows the live clams 20′ to be shipped at colder shipping temperatures than conventional shipping packages (e.g. mesh bag 200). In one embodiment, one of the reasons for this is a phenomenon called brumation which is an ability of cold blooded species (e.g. clams) to survive at very cold temperatures (e.g. at about 37 F or in a range from about 34 F to about 40 F) without dying.

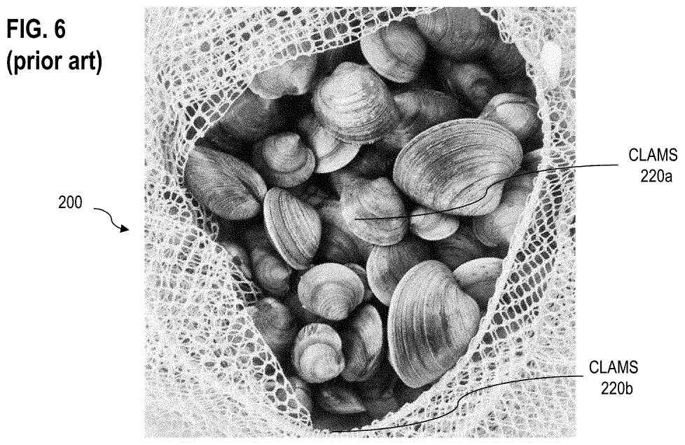

FIG. 4B is a bar graph 50 that illustrates an example of a percentage of saleable live clams versus number of days after harvest, for conventional packaged live clams and live clams packaged using the system of FIGS. 1A and 1B, according to an embodiment. The horizontal axis 52 is the number of days since harvest (e.g. since step 102) in units of days. The vertical axis 54 is the percentage of the live clams 20′ in the container 24 that are saleable, e.g. a percentage of the live clams 20′ that are still alive and/or are still sufficiently fresh to be safely consumed. After 5 days from the harvest and step 102, about 100% of the live clams packaged using the method of FIG. 5 (left bar) are saleable and about 90% of the live clams packaged using conventional packaging (e.g. mesh bag 200 of FIG. 6) are saleable. After 7 days from the harvest and step 102, about 100% of the live clams packaged using the method of FIG. 5 (left bar) are saleable whereas only about 50% of the live clams packaged using the conventional packaging (e.g. mesh bag 200 of FIG. 6) are saleable. After 14 days from the harvest and step 102, about 100% of the live clams packaged using the method of FIG. 5 (left bar) are saleable whereas only about 5% of the live clams packaged using the conventional packaging (e.g. mesh bag 200 of FIG. 6) are saleable. Thus, the method and system advantageously extends the shelf life of the live clams 20 and thus provides live clam harvesters (e.g. tropical region harvesters) with access to additional vendors previously outside the shipping radius using the conventional mesh bag 200 packaging. This opens up live clam harvesters to previously inaccessible buyer markets that were previously outside the shipping radius since the method and system expands the shipping radius of the live clams. In an example embodiment, clam harvesters in tropical regions (e.g. Florida) with short harvesting time and relatively warm sea water 12 (e.g. above about 85 F) can now package the live clams 20′ using the method of FIG. 5 and can successfully transport the live clams 20′ to previously inaccessible retail markets (e.g. Northeast region of United States, Pacific Northwest region of United States, etc) since the live claims 20′ stay alive for at least 14 days.

It will be understood that each of the steps described above, or two or more together, may also find a useful application in other types of constructions differing from the types described above.

While the invention has been illustrated and described as an embodiment of a method for packaging live clams, accordingly it is not limited to the details shown, since it will be understood that various omissions, modifications, substitutions and changes in the forms and details the device illustrated and its operation can be made by those skilled in the art without departing in any way from the sprint of the present invention. The teachings of all of the references cited herein are incorporated by reference to the extent not inconsistent with the teachings herein.

1. A method for packaging live clams in a container, comprising:
placing live clams harvested from sea water having a first temperature in a tank of sea water having a second temperature that is less than the first temperature;
drying, with a blowing device, an outside surface of the live clams after removing the live clams from the tank;
placing a number of the live clams in the container after the drying step; and
applying a vacuum seal along a top of the container and over the live clams in the container.

2. The method according to claim 1, wherein the live claims harvested from sea water having a first temperature comprise farm raised live clams removed from a clam farm comprising the sea water or wild caught live clams removed from the ocean.

3. The method according to claim 1, wherein the sea water having the second temperature has a higher dissolved oxygen level than the sea water having the first temperature and wherein the live clams are placed in the tank for a minimum time sufficient for the live clams to absorb the higher dissolved oxygen level of the sea water having the second temperature.

4. The method according to claim 3, wherein the minimum time is at least 6 hours.

5. The method according to claim 1, wherein the first temperature is in a range from about 80 F to about 100 F and wherein the second temperature is in a range from about 50 F to about 70 F.

6. The method according to claim 1, wherein the placing the live clams in the tank removes sand inside gills of the live clams and exposes the live clams to sea water at the second temperature having a higher dissolved oxygen level than the sea water at the first temperature.

7. The method according to claim 1, wherein the drying step comprises blowing nitrogen gas on the outside surface of the live clams.

8. The method according to claim 7, wherein the blowing step comprises moving the live clams, with a conveyor belt, through a nitrogen gas tunnel that comprises the blowing device.

9. The method according to claim 7, further comprising adjusting a temperature of the nitrogen gas and a time that the live clams are exposed to the nitrogen gas so that the outside surface of the live clams is dried by the nitrogen gas and the live clams remain alive.

10. The method according to claim 9, wherein the temperature is adjusted in a range from about −30 F to about −10 F and the time is adjusted in a range from about 3 minutes to about 7 minutes.

11. The method according to claim 1, wherein the applying step comprises:
removing, with a vacuum skin machine, ambient air from the container; and
applying, with the vacuum skin machine, the vacuum seal comprising a film along the top of the container and over the live clams in the container, wherein a pressure of the film applied over the clams is based on a pressure of sand applied to the live clams in a natural ocean environment.

12. The method according to claim 11, wherein the pressure of the film applied over the clams is in a range from about 1 pound to about 5 pounds.

13. The method according to claim 11, wherein the removing step is performed such that a level of oxygen in the container is based on a level of absorbed oxygen in the sea water at the first temperature.

14. The method according to claim 11, wherein the film has a thickness in a range from about 4 mil to about 8 mil.

15. The method according to claim 1, wherein the live clams are one of mercenaria mercenaria and mercenaria camphensis and wherein a shelf life of the live clams after being packaged in the container is at least 14 days.

16. A system for packaging live clams in a container, comprising:
a tank of sea water at a second temperature, wherein the tank is configured so that live clams are harvested from sea water having a first temperature greater than the second temperature and placed in the tank;
a blowing device configured to dry an outside surface of the live clams after being removed from the tank; and
a vacuum skin machine configured to apply a vacuum seal along a top of a container in which a number of the live clams are placed and configured to apply the vacuum seal over the live clams in the container.

17. The system according to claim 16, wherein the second temperature is in a range from about 50 F to about 70 F and the first temperature is in a range from about 80 F to about 100 F

18. The system according to claim 16, wherein blowing device is a nitrogen gas tunnel configured to dry the outside surface of the live clams guided through the nitrogen gas tunnel with a conveyor belt.

19. The system according to claim 16, wherein one or more settings of the vacuum skin machine are configured such that a pressure of the vacuum seal applied over the live clams is based on a pressure of sand applied to the live clams in an ocean environment.

20. A shipping container comprising one or more containers of live clams formed by the method of claim 1, wherein the live clams have a shelf life of at least 14 days after being packaged in the one or more containers.
